(19) United States
(12) Patent Application Publication
(10) Pub. No.: US 2026/0119419 A1
(43) Pub. Date: Apr. 30, 2026

(54) DIRECT MEMORY ACCESS CONTROLLER, HETEROGENEOUS DEVICE, MEMORY ACCESS METHOD, AND MEDIUM

(71) Applicant: IEIT SYSTEMS CO., LTD., Jinan, Shandong (CN)

(72) Inventors: Hongliang WANG, Jinan, Shandong (CN); Qi MU, Jinan, Shandong (CN); Wei LIU, Jinan, Shandong (CN); Rengang LI, Jinan, Shandong (CN)

(21) Appl. No.: 19/143,887

(22) PCT Filed: Dec. 15, 2023
(86) PCT No.: PCT/CN2023/139257

§ 371 Date: Jun. 26, 2025

(30) Foreign Application Priority Data
Apr. 7, 2023 (CN) 202310362884.4

(51) Int. Cl. G06F 13/16; G06F 13/22; G06F 13/28

(52) U.S. Cl. CPC G06F 13/1689; G06F 13/22; G06F 13/28

(57) ABSTRACT

The present application discloses a direct memory access controller, a heterogeneous device, a memory access method and a medium. The direct memory access controller comprises read descriptor management modules, write descriptor management modules, a read data mover and a write data mover, one read descriptor management module/write descriptor management module corresponds to a management channel of a physical function/virtual function: each read descriptor management module is used for converting content in a descriptor register into a read descriptor and converting read descriptor data into a read descriptor, each write descriptor management module is used for converting write descriptor data into a write descriptor, the read data mover is used for sending a read request to a superordinate computer, receiving first data and performing data processing, and the write data mover is used for reading corresponding second data, generating a write request and sending the write request to the superordinate computer.

### CROSS-REFERENCE TO RELATED APPLICATION

The present application claims the priority of the Chinese Patent application filed on Apr. 7, 2023 before the CNIPA, China National Intellectual Property Administration with the application number of 202310362884.4, and the title of “DIRECT MEMORY ACCESS CONTROLLER, HETEROGENEOUS DEVICE, MEMORY ACCESS METHOD AND MEDIUM”, which is incorporated herein in its entirety by reference.

### FIELD

The present application relates to the technical field of memory access, and particularly to a direct memory access controller, a heterogeneous device, a memory access method and a non-transitory readable storage medium.

### BACKGROUND

Single root I/O virtualization (SR-IOV) is an input/output (I/O) virtualization standard, facilitates the improvement of the performance of a virtual cloud computing platform, and has a core idea that: on the premise of device support, a device is divided into one Physical Function (PF) unit and a plurality of Virtual Function (VF) units. Each virtual function unit may be used as a lightweight I/O device for a virtual machine. In this way, one device may be allocated to a plurality of virtual machines, thereby solving the problem of poor expandability of a virtualization system caused by the limitation of the number of devices. In a Direct Memory Access (DMA) mode, data transfer is completed by a direct memory access controller, and thus occupies very little CPU resources. At present, there are two ways to achieve DMA: chained DMA and block DMA modes. The chained DMA mode is more flexible and efficient than the block DMA mode.

In related technologies, in a chained direct memory access controller, each VF is split at receiving and sending interfaces, and each VF has an independent DMA controller. However, a solution that each VF has an independent DMA controller causes great waste of hardware resources, and a single direct memory access controller cannot support single root I/O virtualization.

### SUMMARY

In view of this, the purpose of the present application is to provide a direct memory access controller, an apparatus, a device and a medium capable of supporting single root I/O virtualization and saving chip resources. The solution is as follows:

In a first aspect, the present application discloses a direct memory access controller, including a plurality of read descriptor management modules, a plurality of write descriptor management modules, a read data mover and a write data mover; wherein one read descriptor management module corresponds to one physical function management channel or one virtual function management channel, and one write descriptor management module corresponds to one physical function management channel or one virtual function management channel;
the read descriptor management modules are configured for converting contents in an obtained descriptor register into read descriptors and converting read descriptor data into read descriptors;
the write descriptor management modules are configured for converting write descriptor data into write descriptors;
the read data mover is configured for sending a read request to a host computer according to the read descriptors, receiving first data corresponding to the read request and processing the data;
the write data mover is configured for reading corresponding second data according to the write descriptors and generating a write request based on the second data to send the write request to the host computer.

In some embodiments, the read descriptor management modules include a register-to-descriptor unit and a first data-to-descriptor unit;
the register-to-descriptor unit is configured for obtaining a read descriptor register and a write descriptor register and converting contents in the registers into read descriptors that conform to a handshake protocol;
the first data-to-descriptor unit is configured for obtaining read descriptor data and converting the read descriptor data into read descriptors that conform to the handshake protocol.

In some embodiments, the write descriptor management modules further include a first merging unit and a first first-in first-out memory;
the first merging unit is configured for polling and merging the read descriptors outputted by the register-to-descriptor unit and the read descriptors outputted by the data-to-descriptor unit by packets;
the first first-in first-out memory is configured for caching the read descriptors outputted by the first merging unit and sending the read descriptors to the read data mover.

In some embodiments, the write descriptor management modules further include a determining unit;
the determining unit is configured for obtaining a write completion information group sent by the write data mover, a read completion information group sent by the read data mover, a read descriptor register and a write descriptor register, generating an interrupt for a relevant physical function/virtual function according to the write completion information group/read completion information group, and generating completion status information for the relevant descriptors.

In some embodiments, the direct memory access controller further includes a second merging unit connected with the read descriptor management module and the read data mover for polling and merging the read descriptors outputted by each read descriptor management module by packets and forwarding the read descriptors to the read data mover.

In some embodiments, the direct memory access controller further includes a first protocol conversion module connected with the host computer and the write descriptor management modules;
the first protocol conversion module is configured for converting received transaction layer data packets of a high-performance expansion bus protocol into transaction layer data packets of a peripheral bus protocol;
the first protocol conversion module includes a completer request interface and a completer completion interface; the completer request interface is configured for receiving a request packet sent by the host computer; and the completer completion interface is configured for returning a completion packet to the host computer.

In some embodiments, the first protocol conversion module includes a request receiving unit, a protocol conversion unit and a sending unit of completion packets with data;
the request receiving unit is configured for receiving and parsing the request packet through the completer request interface, and converting parsed request data into request data of the handshake protocol;
the protocol conversion unit is configured for converting the request data of the handshake protocol into request data of the peripheral bus protocol and sending the request data to a corresponding read descriptor management module through a peripheral bus;
the sending unit of completion packets with data is configured for assembling completion packets with data and sending the packets to the host computer.

In some embodiments, the direct memory access controller further includes a second protocol conversion module connected with the first protocol conversion module;
the second protocol conversion module is configured for converting data packets of the peripheral bus protocol into data packets of the high-performance expansion bus protocol, so that business module buses are interconnected.

In some embodiments, the write descriptor management modules include a second data-to-descriptor unit and a second first-in first-out memory;
the second data-to-descriptor unit is configured for obtaining the write descriptor data and converting the write descriptor data into write descriptors that conform to the handshake protocol;
the second first-in first-out memory is configured for caching the write descriptors outputted by the second data-to-descriptor unit and sending the write descriptors to the write data mover.

In some embodiments, the direct memory access controller further includes:
a third merging unit connected with the write descriptor management modules and the write data mover for polling and merging the write descriptor outputted by each write descriptor management module by packets and forwarding the write descriptors to the write data mover.

In some embodiments, the direct memory access controller further includes:
a descriptor status upload module for converting status information after the completion of the read descriptors and the write descriptors into transaction layer data packets of a write request type and sending the data packets to the host computer.

In some embodiments, the direct memory access controller further includes:
a third protocol conversion module connected with the read data mover, the write data mover and an external memory for converting the data transmitted by the read data mover and the write data mover respectively to the external memory into the high-performance expansion bus protocol.

In some embodiments, the write data mover includes a write calculation control unit, a third first-in first-out memory, a write request sending unit, a sending control unit and a read control unit;
the write calculation control unit is configured for receiving the write descriptor, splitting the write descriptor into a write destination address and a write data length, and sending the write descriptor to the read control unit;
the read control unit is configured for reading corresponding second data from an external memory according to the write descriptor and sending the second data to the write request sending unit;
the write request sending unit is configured for generating transaction layer data packets based on the second data sent by the read control unit and sending the transaction layer data packets to the sending control unit;
the sending control unit is configured for generating a write request and sending the write request to the host computer when the data volume of the received transaction layer data packets meets sending conditions of the bus protocol.

In some embodiments, the write data mover further includes a third first-in first-out memory connected with the read control unit, and a data cache unit connected with the third first-in first-out memory and the write request sending unit;
the third first-in first-out memory is configured for storing the second data sent by the read control unit and forwarding the second data to the data cache unit;
the data cache unit is configured for caching the second data sent by the third first-in first-out memory in two-word units, and sending the cached data to the write request sending unit when the volume of the cached data meets the sending conditions of the write request sending unit.

In some embodiments, the read data mover includes a read calculation control unit, a splitting unit, a read request sending unit, a storage unit of completion packets with data, a receiving unit of completion packets with data and a write control unit;
the read calculation control unit is configured for receiving the read descriptor and splitting the read descriptor into a read destination address and a read data length;
the splitting unit is configured for generating three pieces of read operation information, with each piece of read operation information including the read destination address and the read data length, sending one piece of read operation information to the read request sending unit, and sending two pieces of read operation information to the write control unit;
the read request sending unit is configured for packing the read destination address and the read data length to obtain a read request, and sending the read request to the host computer;
the receiving unit of completion packets with data is configured for receiving completion packets with data sent by the host computer through the requester completion interface, preprocessing data for the completion packets with data, and then forwarding the preprocessed completion packets with data to the receiving unit of completion packets with data;
the storage unit of completion packets with data is configured for storing the preprocessed completion packets with data and forwarding the preprocessed completion packets with data to the write control unit;
the write control unit is configured for controlling a write address and a write length of the external memory according to the read operation information, generating corresponding read completion information or read descriptor data or write descriptor data according to the read operation information and the completion packets with data, sending the read completion information or the read descriptor data to the read descriptor management modules, and sending the write descriptor data to the write descriptor management modules.

In some embodiments, the read data mover further includes a tag management unit;
the tag management unit is configured for receiving tags written by the storage unit of completion packets with data whenever receiving one completion packet with data, and sending the tags to the read request sending unit for addition to the read request.

In some embodiments, the storage unit of completion packets with data is divided into a preset number of cache spaces to use the cache spaces to sequentially cache the completion packets with data received out of order.

In a second aspect, the present application discloses a heterogeneous device, including the above direct memory access controller.

In a third aspect, the present application discloses a direct memory access system, including a host computer and the above direct memory access controller, and the host computer is connected with the direct memory access controller through a high-speed serial computer expansion bus standard interface.

In a fourth aspect, the present application discloses a server connected with the above direct memory access controller and configured for data interaction with the direct memory access controller.

In a fifth aspect, the present application discloses a direct memory access method, which is applied to the above direct memory access controller and includes:
converting, by the read descriptor management modules, contents in an obtained descriptor register into read descriptors, and converting read descriptor data into read descriptors;
converting write descriptor data into write descriptors by the write descriptor management modules;
sending, by the read data mover, a read request to the host computer according to the read descriptors, receiving first data corresponding to the read request and processing the data; and
reading, by the write data mover, corresponding second data according to the write descriptors, and generating a write request based on the second data to send the write request to the host computer.

In a sixth aspect, the present application discloses a non-transitory readable storage medium for storing computer programs, wherein the computer programs, when executed by a processor, implement the above direct memory access method.

In some embodiments of the present application, the direct memory access controller includes a plurality of read descriptor management modules, a plurality of write descriptor management modules, a read data mover and a write data mover; wherein one read descriptor management module corresponds to one physical function management channel or one virtual function management channel, and one write descriptor management module corresponds to one physical function management channel or one virtual function management channel; the read descriptor management modules are configured for converting contents in an obtained descriptor register into read descriptors and converting read descriptor data into read descriptors; the write descriptor management modules are configured for converting write descriptor data into write descriptors; the read data mover is configured for sending a read request to a host computer according to the read descriptors, receiving first data corresponding to the read request and processing the data; and the write data mover is configured for reading corresponding second data according to the write descriptors and generating a write request based on the second data to send the write request to the host computer. It can be seen that by configuring independent read descriptor management modules and write descriptor management modules for each physical function management channel and each virtual function management channel, a chained direct memory access controller suitable for single root I/O virtualization is implemented. That is, each descriptor management module for physical functions and virtual functions is independent, and is shared by the read data mover and the write data mover, thereby supporting single root I/O virtualization. Moreover, the number of the physical functions/virtual functions can be expanded arbitrarily, and the data movers can be shared to save chip resources.

### BRIEF DESCRIPTION OF THE DRAWINGS

To more clearly illustrate the technical solutions in some embodiments of the present application or in the prior art, the drawings to be used in the description of the embodiments or the prior art will be simply explained below. Obviously, the drawings described below are merely the embodiments of the present application. For those ordinary skilled in the art, other drawings can also be obtained according to the provided drawings without contributing creative labor.

FIG. 1 is a schematic structural diagram of a direct memory access controller provided by the present application;

FIG. 2 is a schematic diagram of a basic structure of an I/O device with SR-IOV capability in a related technology;

FIG. 3 is a schematic diagram of an I/O virtualization architecture of an SR-IOV device in a related technology;

FIG. 4 is a schematic structural diagram of a direct memory access controller provided by the present application;

FIG. 5 is a schematic structural diagram of a first protocol conversion module provided by the present application;

FIG. 6 is a schematic structural diagram of a read descriptor management module provided by the present application;

FIG. 7 is a schematic structural diagram of a write descriptor management module provided by the present application;

FIG. 8 is a schematic structural diagram of a write data mover provided by the present application;

FIG. 9 is a schematic structural diagram of a read data mover provided by the present application;

FIG. 10 is a flowchart of a direct memory access method provided by the present application.

### DETAILED DESCRIPTION

To make the purpose, the technical solutions and the advantages of some embodiments of the present application more clear, the technical solutions in some embodiments of the present application will be clearly and fully described below in combination with the drawings in some embodiments of the present application. Apparently, the described embodiments are merely part of the embodiments of the present application, not all of the embodiments. Based on the embodiments in the present application, all other embodiments obtained by those ordinary skilled in the art without contributing creative labor will belong to the protection scope of the present application.

In the prior art, in a chained direct memory access controller, each VF is split at receiving and sending interfaces, and each VF has an independent DMA controller. However, a solution that each VF has an independent DMA controller causes the waste of a large number of hardware resources, and a single direct memory access controller cannot support single root I/O virtualization. To solve the technical problems above, the present application discloses a direct memory access controller capable of supporting single root I/O virtualization and saving chip resources.

Some embodiments of the present application disclose a direct memory access controller, as shown in FIG. 1. The direct memory access controller may include a plurality of read descriptor management modules 11, a plurality of write descriptor management modules 13, a read data mover 12 and a write data mover 14; wherein one read descriptor management module corresponds to one physical function management channel or one virtual function management channel, and one write descriptor management module corresponds to one physical function management channel or one virtual function management channel. That is, the read descriptor management modules for each physical function and each virtual function are independent, and the write descriptor management modules for each physical function and each virtual function are also independent. For example, currently, 2 physical functions pf0 and pf1 and 4 virtual functions vf0-vf3 are configured. Each virtual function or physical function corresponds to an independent read descriptor management module and a write descriptor management module. Then, the direct memory access controller currently needs to use 6 read descriptor management modules and 6 write descriptor management modules. It should be noted that in the embodiments, the read descriptor management modules, the write descriptor management modules, the read data mover and the write data mover above are all hardware circuits.

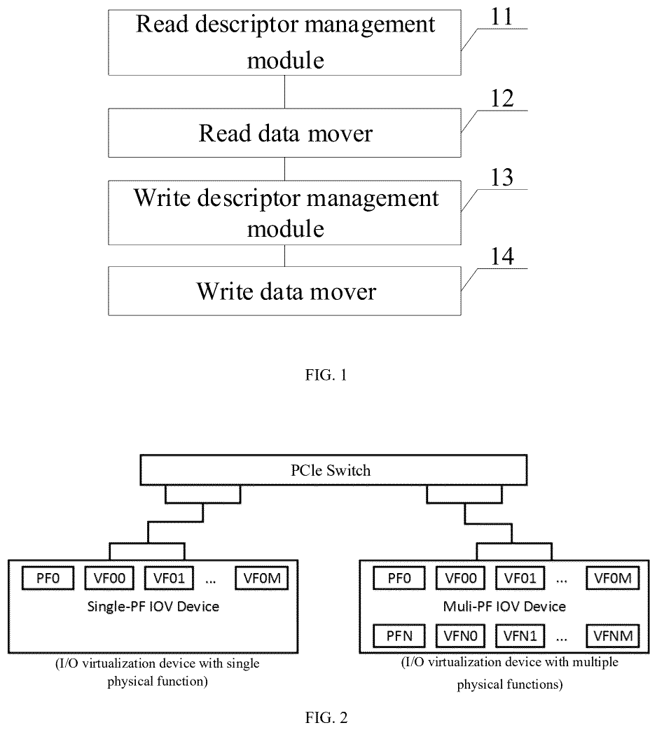

Firstly, Single Root I/O Virtualization (SR-IOV) is briefly described. SR-IOV is currently a hot-spot issue in the research of I/O virtualization, aiming to achieve hardware-level device virtualization. A mechanism for efficiently sharing Peripheral Component Interconnect express (PCIe, which is a high-speed serial computer expansion bus standard) device is established between clients, so as to obtain the same I/O performance and efficiency as this machine. Relevant experimental analysis shows that the data transmission efficiency and CPU utilization rate of a system that applies the SR-IOV technology are significantly improved, which is of great value for large-scale high-performance computing clusters. According to the protocol standard, one SR-IOV device may have one or more physical functions (PF), and PF may be regarded as a standard traditional PCIe device. Each PF may create a plurality of virtual functions (VF). VF is configured and managed by PF. Compared with PF, VF is a lightweight PCIe device. The basic structure of an I/O device with SR-IOV capability is shown in FIG. 2. The left is a device structure of a single PF, and M VFs are virtualized from one PF. The right is a device structure with N PFs, and each PF may virtualize M VFs. The characteristics of virtualization itself determine that a virtual device is ultimately limited by actual physical resources. The performance of VF is related to the quantity and the allocation modes of hardware resources.

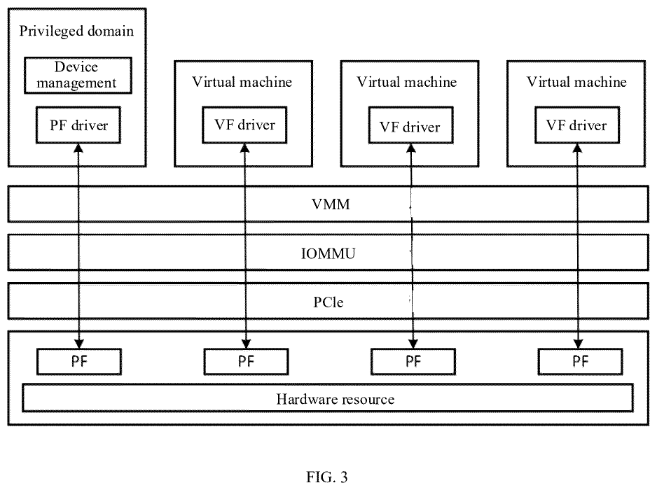

SR-IOV adopts a device transparent transmission technology. The system allocates each VF to different virtual machines for use, and the virtual machines have the capability to directly use VF for data processing. The device transparent transmission technology bypasses a Virtual Machine Monitor (VMM) to directly send and receive I/O data. A client performs I/O operation through VF drivers, and this process does not require the interference of the virtual machine monitor. This not only increases the isolation between virtual machines, but also makes efficiency close to the raw performance of the device. The I/O virtualization architecture of the SR-IOV device is shown in FIG. 3.

A PF driver may directly access the configuration space of PF and physical resources occupied by PF in the device. Its primary function is responsible for configuring and managing all VFs, setting the number of VFs through PCIe expansion configuration spaces, and globally enabling or disabling VFs from a host machine level. Secondly, the PF driver may call the physical resources to which PF belongs, such as algorithms of PF, etc. The VF driver may be regarded as an ordinary PCIe device driver from the perspective of the client, and may directly access a VF device assigned by an SR-IOV manager to the client. Because a hardware Input/Output Memory Management Unit (IOMMU) performs address translation, the VF driver may complete data transfer directly by operating the physical address of the client without the intervention of the VMM. The SR-IOV manager creates a virtual configuration space for all VFs, to allow a host operating system to correctly identify and configure VFs. VFs are correctly recognized and configured by a host machine, then allocated to the client, and initialized and used as an ordinary PCIe device in a client operating system. IOMMU accomplishes memory access authorization and memory address translation. IOMMU converts the physical address of the client of the VF driver into the physical address of the host machine through a remapping mode, that is, translates the memory address of a client buffer into the physical address of the machine. For reverse operation, IOMMU also supports remapping, that is, access from the device to the client.

In some embodiments, the read descriptor management modules (Read Descriptor Manage) are configured for converting contents in an obtained descriptor register into read descriptors and converting read descriptor data into read descriptors. That is, a descriptor control register and the operation are converted into the read descriptors; and the read descriptor data read back by the host computer are parsed into a read descriptor format. It is understandable that the read descriptors obtained from the conversion of the descriptor control register are configured for reading the read descriptors and the write descriptors prepared by the host computer.

In some embodiments, the write descriptor management modules (Write Descriptor Manage) are configured for converting write descriptor data into write descriptors. That is, the write descriptor data read back by the host computer are parsed into a write descriptor format.

In some embodiments, the read data mover (Read DMA Dtata Mover) is configured for sending a read request to the host computer according to the read descriptors, receiving first data corresponding to the read request and processing the data. That is, a memory read request (Mrd) of a read request Transaction Layer Packet (TLP, a transaction layer data packet of a PCIe protocol) type is sent according to the read descriptors, and then the host computer processes the request according to the data returned by the read request. The returned data may include, but is not limited to, read and write descriptor data, normal data, etc.

In some embodiments, the write data mover (Write DMA Data Mover) is configured for reading corresponding second data according to the write descriptors and generating a write request based on the second data to send the write request to the host computer. The main function of the module is to read data from a read data interface according to the write descriptors, then convert the data into a TLP-type memory write request (Mwr) and send the data to the host computer.

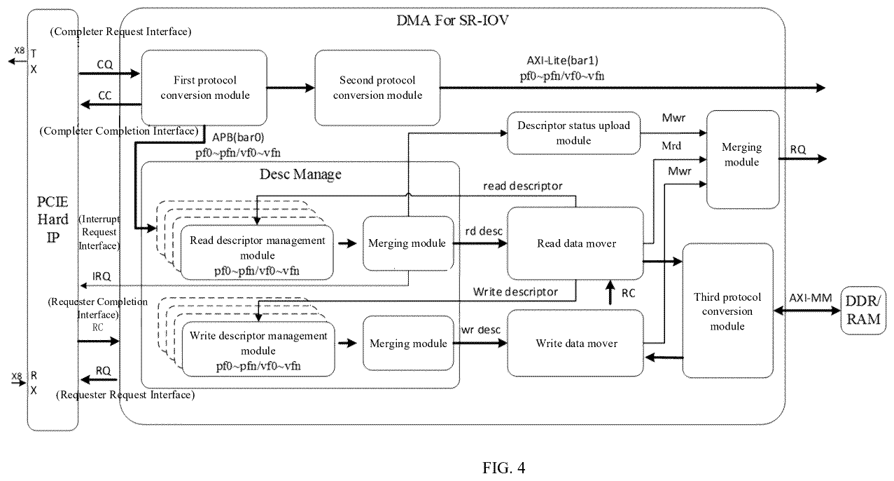

For example, as shown in FIG. 4 that shows a direct memory access control framework diagram, it can be understood that PCIe stipulates own specifications, which is not performed by DMA. A DMA controller may be regarded as an application of PCIe and configured for moving large amounts of data. In FIG. 4, PCIE Hard IP is a Peripheral Component Interconnect Express (PCIE, a high-speed serial computer expansion bus standard) hardcore module responsible for a physical layer and a protocol layer of PCIE; CQ, CC, RC and RQ are TLP packet interfaces for the direct memory access controller to interact with the hardcore; and IRQ is an interrupt interaction interface. The interface is described as follows: CQ (Completer request interface) is configured for a user application to receive request packets from the host computer; CC (Completer completion interface) is configured for the user application to return completion packets to the host computer; RC (Requester Completion Interface) is configured for the user application to receive completion packets from the host computer; RQ (Requester Request Interface) is configured for the user application to send the request packets to the host computer; and IRQ (Interrupt Request Interface) is configured for the user application to request interrupts from the host computer.

In some embodiments, the direct memory access controller further includes a first protocol conversion module (TLP2BAR) connected with the host computer and the write descriptor management modules; the first protocol conversion module is configured for converting received transaction layer data packets of a high-performance expansion bus protocol (Advanced Extensible Interface, AXIS) into transaction layer data packets of a peripheral bus protocol; the first protocol conversion module includes a completer request interface and a completer completion interface; the completer request interface is configured for receiving a request packet sent by the host computer; and the completer completion interface is configured for returning a completion packet to the host computer. That is, the host computer performs read and write operation of a Base Address Register (BAR) which is converted into read and write TLP through the PCIE protocol. The module is responsible for parsing the TLP from the interface CQ (AXIS protocol) and converting the TLP into the read and write operation of an APB bus. The write operation of the host computer is converted into the write operation of the APB bus, the read operation of the host computer is converted into the read operation of the APB bus, and the completion packet with data (i.e., the completion TLP with data, Cpld) is returned to the host through the interface CC (AXIS bus). The CQ interface is marked with a PF/VF identifier and a bar0-bar5 identifier. Theoretically, if the total number of PF/VF is n, 6×n sets of APB buses are required to correspond. In some embodiments, if bar0 is designed to be responsible for configuring a DMA-related register and bar1 is designed to be responsible for configuring other service-related registers, then 2×n sets of APB buses are needed and the base address register may be modified and designed as needed. It should be noted that in some embodiments, the above first protocol conversion module is a hardware circuit.

In some embodiments, the first protocol conversion module includes a request receiving unit, a protocol conversion unit and a sending unit of completion packets with data; the request receiving unit is configured for receiving and parsing the request packet through the completer request interface, and converting parsed request data into request data of the handshake protocol; the protocol conversion unit is configured for converting the request data of the handshake protocol into request data of the peripheral bus protocol and sending the request data to a corresponding read descriptor management module through a peripheral bus; and the sending unit of completion packets with data is configured for assembling completion packets with data and sending the packets to the host computer.

For example, as shown in FIG. 5, CQ and CC are the TLP transmission interfaces of the AXIS bus; CQ receives the read and write operation of the host computer; TLP has Mwr and Mrd, corresponding to the read and write operation of the bar space; and CC is a returned data packet Cpld of the sub-device. The request receiving unit (Rx_host_req) is responsible for parsing Mwr and Mrd of the AXIS protocol and converting Mwr and Mrd into request data (cmd_info) based on a ready/valid handshake protocol. The carried information mainly includes read/write flags, write data addresses, write data, read data addresses, bar identifiers, PF/VF identifiers, tags, tc flags, func functions, etc. The protocol conversion unit (cmd_info2apb) converts cmd_info into read/write request data of the apb protocol. If it is the read data, cmd_info identification information and the read data of APB are sent to the sending unit of completion packets with data (tx_bar_cpld) and the sending unit of completion packets with data module combines information such as tags, read data, tc flags, etc. into a completion packet with data and returns the packet to the host computer.

In some embodiments, the direct memory access controller further includes a second protocol conversion module connected with the first protocol conversion module; and the second protocol conversion module is configured for converting data packets of the peripheral bus protocol into data packets of the high-performance expansion bus protocol, so that business module buses are interconnected. As shown in FIG. 4, the second protocol conversion module (APB2AXI-Lite) converts a standard APB bus into an AXI-Lite bus, to facilitate the interconnection of service module buses. It should be noted that in some embodiments, the above second protocol conversion module is a hardware circuit.

In some embodiments, the direct memory access controller also includes: a descriptor status upload module for converting status information after the completion of the read descriptors and the write descriptors into transaction layer data packets of a write request type and sending the data packets to the host computer. As shown in FIG. 4, the descriptor status upload module (Desc Status Upload) has a function of converting the status information after completion of each descriptor into a Mwr type TLP and sending TLP to the host computer. The host computer reserves a status flag storage space for each descriptor. For example, after one descriptor is completed, 1 is written to the corresponding host computer address. It should be noted that in some embodiments, the above descriptor status upload module is a hardware circuit.

In some embodiments, the direct memory access controller further includes: a third protocol conversion module connected with the read data mover, the write data mover and an external memory for converting the data transmitted by the read data mover and the write data mover respectively to the external memory into the high-performance expansion bus protocol. As shown in FIG. 4, the third protocol conversion module (Std_Intf) has a function of converting the read and write data of non-standard protocols transmitted by the read data mover and the write data mover into AXI-MM standard protocols. It should be noted that in some embodiments, the above third protocol conversion module is a hardware circuit.

In some embodiments, the direct memory access controller further includes a merging module connected with the read data mover, the write data mover and the descriptor status upload module. The module has a main function of polling and merging multi-stream mode data outputted by the read data mover, the write data mover and the descriptor status upload module by packets. It should be noted that in some embodiments, the above merging module is a hardware circuit.

It can be seen that in some embodiments, an architecture of the direct memory access controller mainly includes the main modules of the first protocol conversion module, the second protocol conversion module, the read descriptor management module, the write descriptor management module, the merging module, the descriptor status upload module, the read data mover, the write data mover, the third protocol conversion module, etc. Each module is a hardware circuit. Data transmission between each module. A large amount of data streams are transmitted among the modules by using standard buses such as axi-stream and axi-mm to ensure transmission efficiency. The read and write operation of the bar is transmitted using standard buses such as apb and axi-lite to ensure specifications. The remaining command information or control information, etc. is transmitted using ready/valid handshake signals to ensure the transmission efficiency of the control information, make the entire architecture an asynchronous pipeline, prevent any module from reducing the efficiency of the direct memory access controller due to waiting, support DMA simultaneous reading and writing, and have high flexibility. Moreover, through modular design, it is convenient for transplantation, modification and maintenance.

Additionally, in some embodiments, a DMA controller suitable for single root I/O virtualization is implemented, and each descriptor control channel corresponds to one physical function or virtual function. When it is desired to become a DMA controller with a single physical function and a plurality of channels, a plurality of descriptor registers only need to be configured on a single physical function. At this time, a plurality of descriptors may still be processed using a plurality of channels. Meanwhile, in some embodiments, after tailored to a single channel, the functions of the controller are basically the same as those of a normal chained descriptor DMA controller.

It can be seen from the above that in some embodiments, the direct memory access controller includes a plurality of read descriptor management modules, a plurality of write descriptor management modules, a read data mover and a write data mover; wherein one read descriptor management module corresponds to one physical function management channel or one virtual function management channel, and one write descriptor management module corresponds to one physical function management channel or one virtual function management channel; the read descriptor management modules are configured for converting contents in an obtained descriptor register into read descriptors and converting read descriptor data into read descriptors; the write descriptor management modules are configured for converting write descriptor data into write descriptors; the read data mover is configured for sending a read request to a host computer according to the read descriptors, receiving first data corresponding to the read request and processing the data; and the write data mover is configured for reading corresponding second data according to the write descriptors and generating a write request based on the second data to send the write request to the host computer. It can be seen that by configuring independent read descriptor management modules and write descriptor management modules for each physical function management channel and each virtual function management channel, a chained direct memory access controller suitable for single root I/O virtualization is implemented. That is, each descriptor management module for physical functions and virtual functions is independent, and is shared by the read data mover and the write data mover, thereby supporting single root I/O virtualization. Moreover, the number of the physical functions/virtual functions can be expanded arbitrarily, and the data movers can be shared to save chip resources.

In some embodiments, for example, as shown in FIG. 6, the above read descriptor management modules may include a register-to-descriptor unit and a first data-to-descriptor unit; wherein the register-to-descriptor unit is configured for obtaining a read descriptor register and a write descriptor register and converting contents in the registers into read descriptors that conform to a handshake protocol; and the first data-to-descriptor unit is configured for obtaining read descriptor data and converting the read descriptor data into read descriptors that conform to the handshake protocol.

For example, as shown in FIG. 6, input signals of the read descriptor management modules mainly include a descriptor register group (desc_reg) from bar read and write, a read descriptor data (read_desc_data) from a host computer parsed by a read data mover, a read completion information group (rdesc_done_info), and a write completion information group (wdesc_done_info) from a write data mover. Wherein the descriptor registers include a read descriptor register (the read descriptor register includes: a source address, a destination address, a length, an ID, a start signal, etc.) and a write descriptor register (the write descriptor register includes: a source address, a destination address, a length, an ID, a start signal, etc.). The register-to-descriptor unit (reg2desc) converts the above registers into a descriptor form based on the handshake protocol. The first data-to-descriptor unit (data2desc) converts these data into read descriptors based on the handshake protocol. Wherein an obtaining process of the read descriptor data is: the register-to-descriptor unit reads the register group to obtain the corresponding read descriptors, and reads the corresponding position of the host computer according to the read descriptors to obtain the read descriptor data for reading data and the write descriptor data for writing data. That is, the read and write descriptor data are both read back from the host computer through the corresponding read descriptors of the registers. The read descriptors read by the register-to-descriptor unit are generated by the descriptor control register, and the descriptor register may be generated through the bar read and write configuration.

In some embodiments, the write descriptor management modules may also include a first merging unit and a first first-in first-out memory; the first merging unit is configured for polling and merging the read descriptors outputted by the register-to-descriptor unit and the read descriptors outputted by the data-to-descriptor unit by packets; and the first first-in first-out memory is configured for caching the read descriptors outputted by the first merging unit and sending the read descriptors to the read data mover. That is, the first merging unit (desc_merge) polls and merges the descriptors outputted by the above register-to-descriptor unit and the data-to-descriptor unit one by one, and stores the descriptors in the first first-in first-out memory (Fifo). The cache depth may be 128 descriptors.

In some embodiments, the write descriptor management modules may also include a determining unit; the determining unit is configured for obtaining a write completion information group sent by the write data mover, a read completion information group sent by the read data mover, a read descriptor register and a write descriptor register, generating an interrupt for a relevant physical function/virtual function according to the write completion information group/read completion information group, and generating completion status information for the relevant descriptors. That is, the determining unit determines whether to generate a corresponding PF/VF interrupt and the completion status information corresponding to each descriptor ID according to the relevant information of read and write completion (PF/VF identifier, descriptor ID, etc.).

In some embodiments, the direct memory access controller may also include: a second merging unit connected with the read descriptor management module and the read data mover for polling and merging the read descriptors outputted by each read descriptor management module by packets and forwarding the read descriptors to the read data mover. For example, as shown in FIG. 4, the second merging unit connected with the read descriptor management module and the read data mover is configured for polling and merging the read descriptors outputted by each read descriptor management module by packets and forwarding the read descriptors to the read data mover. Thus, the read descriptors may be successively processed roughly in a receiving order.

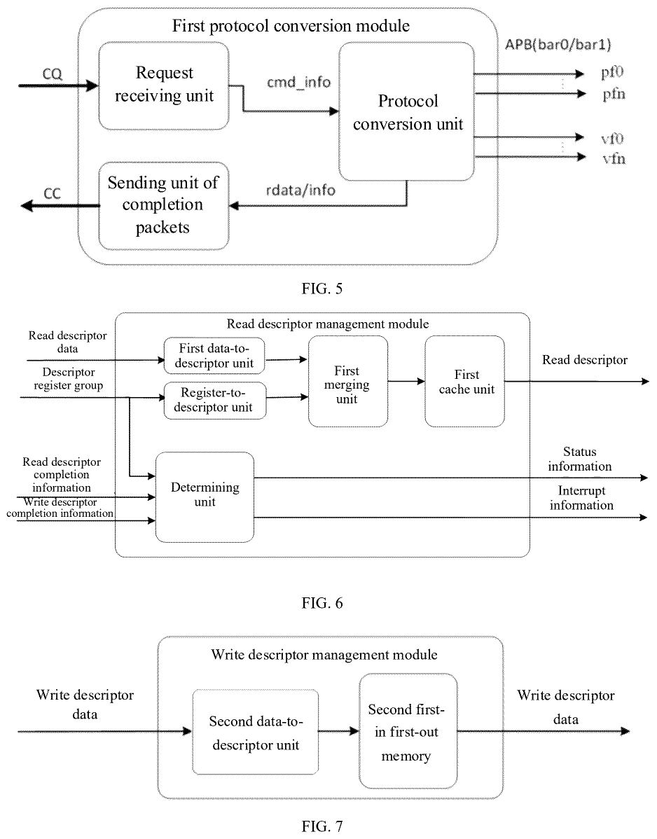

In some embodiments, for example, as shown in FIG. 7, the write descriptor management modules may include a second data-to-descriptor unit and a second first-in first-out memory; wherein the second data-to-descriptor unit is configured for obtaining the write descriptor data and converting the write descriptor data into write descriptors that conform to the handshake protocol; and the second first-in first-out memory is configured for caching the write descriptors outputted by the second data-to-descriptor unit and sending the write descriptors to the write data mover. The second data-to-descriptor unit (data2desc) converts the write descriptor data (write_desc_data) into write descriptors based on the handshake protocol and stores the data in the second first-in first-out memory (Fifo).

In some embodiments, the direct memory access controller may also include: a third merging unit connected with the write descriptor management modules and the write data mover for polling and merging the write descriptor outputted by each write descriptor management module by packets and forwarding the write descriptors to the write data mover. That is, as shown in FIG. 4, the third merging unit connected with the write descriptor management module and the write data mover is configured for polling and merging the write descriptors outputted by each write descriptor management module by packets and forwarding the write descriptors to the write data mover. Thus, the write descriptors may be successively processed roughly in a receiving order.

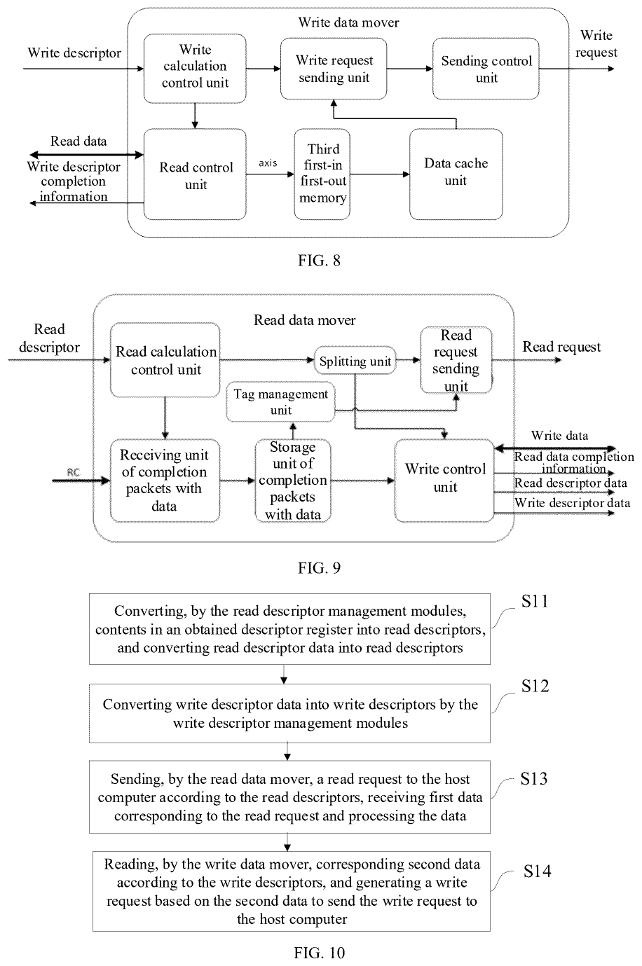

In some embodiments, for example, as shown in FIG. 8, the write data mover may include a write calculation control unit, a third first-in first-out memory, a write request sending unit, a sending control unit and a read control unit; wherein the write calculation control unit is configured for receiving the write descriptor, splitting the write descriptor into a write destination address and a write data length, and sending the write descriptor to the read control unit; the read control unit is configured for reading corresponding second data from the external memory according to the write descriptor and sending the second data to the write request sending unit; the write request sending unit is configured for generating the transaction layer data packets based on the second data sent by the read control unit and sending the transaction layer data packets to the sending control unit; and the sending control unit is configured for generating a write request and sending the write request to the host computer when the data volume of the received transaction layer data packets meets sending conditions of the bus protocol.

It is understandable that because the length of the write descriptor is limited by the data carrying capacity (Max_Payload_Size) of a sending end specified by PCIe and the 4k address boundary, the write calculation control unit (write_calc_ctrl) splits one write descriptor into a plurality of satisfactory write destination addresses and write data lengths, transfers the split information to the write request sending unit (tx_mwr), and simultaneously transfers the write descriptor to the read control unit (read_ctrl). The read control unit pre-reads the data of the corresponding length at the source address according to the descriptor, processes the data into ab AXIS format, transfers the data to the write request sending unit, and transfers the write descriptor completion information (wdesc_done_info) after reading the data of the corresponding length. The write request sending unit is responsible for integrating and packaging the split information and data. The sending control unit (axis_valid_keep) caches at least one packet of packaged data. Only when the complete data packet is fully cached, the packet of data may be sent. This mechanism is to prevent the problem of PCIE link errors caused by long-time disconnection in the middle of a packet of data in the AXIS stream mode.

In some embodiments, the write data mover may also include a third first-in first-out memory connected with the read control unit, and a data cache unit connected with the third first-in first-out memory and the write request sending unit; the third first-in first-out memory is configured for storing the second data sent by the read control unit and forwarding the second data to the data cache unit; and the data cache unit is configured for caching the second data sent by the third first-in first-out memory in two-word units, and sending the cached data to the write request sending unit when the volume of the cached data meets the sending conditions of the write request sending unit. It is understandable that the write request sending unit needs to form TLP packets, send frame headers and data, and send uncertain number of Double Words (DW, that is, 4 bytes) each time, and the data starting positions for transmission each time by the AXIS bus protocol and the number of valid DWs are also uncertain. Therefore, a data cache unit (Mwr_data_cache) is added to treat the problem. The data cache unit performs two small caches on the AXIS bus data and standardizes the uncertain positions of the data. After the number of sent data required by the write request sending unit is cached in units of DW, a handshake may be completed, i.e., data transfer. The data cache unit and the mechanism of prefetching and then caching the data to a third first-in first-out memory are the keys to maximize the entire write DMA rate. Therefore, the module cannot be designed with a state machine. Design without using the state machine makes it easy for states to frequently jump, thereby reducing efficiency. In some embodiments, a ready/valid handshake circuit is configured for data caching and related control.

In some embodiments, the read data mover may include a read calculation control unit, a splitting unit, a read request sending unit, a storage unit of completion packets with data, a receiving unit of completion packets with data and a write control unit; wherein the read calculation control unit is configured for receiving the read descriptor and splitting the read descriptor into a read destination address and a read data length; the splitting unit is configured for generating three pieces of read operation information, with each piece of read operation information including the read destination address and the read data length, sending one piece of read operation information to the read request sending unit, and sending two pieces of read operation information to the write control unit; the read request sending unit is configured for packing the read destination address and the read data length to obtain a read request, and sending the read request to the host computer; the receiving unit of completion packets with data is configured for receiving completion packets with data sent by the host computer through the requester completion interface, preprocessing data for the completion packets with data, and then forwarding the preprocessed completion packets with data to the receiving unit of completion packets with data; the storage unit of completion packets with data is configured for storing the preprocessed completion packets with data and forwarding the preprocessed completion packets with data to the write control unit; and the write control unit is configured for controlling a write address and a write length of the external memory according to the read operation information, generating corresponding read completion information or read descriptor data or write descriptor data according to the read operation information and the completion packets with data, sending the read completion information or the read descriptor data to the read descriptor management modules, and sending the write descriptor data to the write descriptor management modules.

For example, as shown in FIG. 9, because the length of the read descriptor is limited by the data carrying capacity of the sending end specified by PCIe and the 4k address boundary, the read calculation control unit (read_calc_ctrl) splits one descriptor into a plurality of satisfactory read destination addresses and read data lengths, and the splitting unit (fork3) splits the information into exactly the same three parts. Each part includes a read destination address and a read data length. Three parts of data need to be changed from synchronous to asynchronous. One part is given to the read request sending unit (tx_mrd), and two parts are given to the write control unit (write_ctrl). After the read request sending unit obtains the read destination address and the read data length, packets are formed and a read data request TLP is sent to the host computer. The receiving unit of completion packets with data (rx_cpld) preprocesses the data packets returned by the host computer, discards irrelevant information such as frame heads, and simultaneously organizes the data into standard AXIS bus protocol data. The storage unit of completion packets with data (Mem_cpld) is composed of RAM and is configured for storing cpld packets. The write control unit (Write_ctrl) mainly controls the write address and the write length of the external memory in advance according to information such as the destination address and the data length (one of the parts of information in fork3), then uses the last part of information in fork3 to perform data normalization processing on the received cpld data, and merges multiple packets into one packet. The data is in units of DW. The purpose of separate control is to preprocess the write addresses and the write lengths. A pre-write mechanism may increase the bandwidth utilization rate of read DMA and is the key to increase to a maximum bandwidth utilization rate. Meanwhile, the module distinguishes whether the read back data is a descriptor or ordinary data, processes and splits the data, and sends the data to the corresponding module. After completing the read operation, the relevant completion information is transferred.

In some embodiments, the read data mover may also include a tag management unit; and the tag management unit is configured for receiving tags written by the storage unit of completion packets with data whenever receiving one completion packet with data, and sending the tags to the read request sending unit for addition to the read request. That is, the tag management unit (Tag_manage) is responsible for managing tags. The number of the tags may be 32. One tag is consumed when one read request is sent. After the storage unit of completion packets with data stores a returned cpld packet, a tag is written to the tag management unit module to complete tag recycling. After the read request sending unit obtains the tag, the read destination address and the read data length, packets are formed and the read data request TLP is sent to the host computer.

In some embodiments, the storage unit of completion packets with data is divided into a preset number of cache spaces to use the cache spaces to sequentially cache the completion packets with data received out of order. That is, the storage unit of completion packets with data may be composed of RAM with a depth of 32×Max_Read_Request_Size (the maximum read data size specified by PCIe), and may cache up to 32 Cpld data packets. If the cache is less than 32×Max_Read_Request_Size, data may be lost. By dividing the cache into 32 small caches and storing the received data packets in sequence, out-of-order reception of CpID may be supported and the data transmission delay of PCIE may be reduced by about 2 us. If out-of-order reception is not required to be supported, the cache may be designed as a large cache.

Further, some embodiments of the present application further disclose a heterogeneous device, including the above direct memory access controller; the heterogeneous device may be a network card, a Field Programmable Gate Array (FPGA) accelerator, a cryptographic card, a Graphics Processing Unit (GPU), a Data Processing Unit (DPU), and other board card devices with PCIe gold fingers. The heterogeneous device conducts interaction of a large amount of data with the host computer through a PCIe interface.

Some embodiments of the present application disclose a direct memory access system, including a host computer and the above direct memory access controller, wherein the host computer is connected with the direct memory access controller through a high-speed serial computer expansion bus standard interface. The above host computer refers to a computer that may directly issue control commands, which may be computer devices with PCIe slots such as a server, a desktop computer in some embodiments of the present application. When the direct memory access system is operated, the direct memory access controller executes the above logic.

Some embodiments of the present application disclose a server, which is connected with the above direct memory access controller for data interaction with the above direct memory access controller.

Some embodiments of the present application disclose a direct memory access method, as shown in FIG. 10. The method may include the following steps:
Step S11: converting, by the read descriptor management modules, contents in an obtained descriptor register into read descriptors, and converting read descriptor data into read descriptors.
Step S12: converting write descriptor data into write descriptors by the write descriptor management modules.
Step S13: sending, by the read data mover, a read request to the host computer according to the read descriptors, receiving first data corresponding to the read request and processing the data.
Step S14: reading, by the write data mover, corresponding second data according to the write descriptors, and generating a write request based on the second data to send the write request to the host computer.

Further, some embodiments of the present application further disclose a non-transitory computer readable storage medium which stores computer executable instructions, and the computer executable instructions, when loaded and executed by a processor, implement the above direct memory access steps disclosed by any of the embodiments.

Each embodiment in the description is described in a progressive way. The difference of each embodiment from each other is the focus of explanation. The same and similar parts among all of the embodiments may be referred to each other. For a device disclosed by the embodiments, because the device corresponds to a method disclosed by the embodiments, the device is simply described. Refer to the description of the method part for the related part.

The steps of the methods or algorithms described in combination with the embodiments disclosed herein may be implemented directly by hardware, a software module executed by a processor, or a combination of both. The software module may be placed in a Random Access Memory (RAM), a memory, a Read-Only Memory (ROM), an electrically programmable ROM, an electrically erasable programmable ROM, a register, a hard disk, a removable magnetic disk, a CD-ROM, or any other form of storage medium known in the technical field.

Finally, it should also be noted that herein, relationship terms such as first, second and the like are just configured for differentiating one entity or operation from another entity or operation, and do not necessarily require or imply any practical relationship or sequence between the entities or operations. Moreover, terms of “comprise”, “include” or any other variant are intended to cover non-exclusive inclusion, so that a process, a method, an article or a device which includes a series of elements not only includes such elements, but also includes other elements not listed clearly or also includes inherent elements in the process, the method, the article or the device. Under the condition of no more limitation, the elements defined by a sentence “include one.” do not exclude additional identical elements in the process, the method, the article or the device which includes the elements.

The direct memory access controller, the apparatus, the device and the medium provided by the present application are described in detail above. Individual cases are applied herein for elaborating the principle and embodiments of the present application. The illustration of the above embodiments is merely configured for helping to understand the method and the core thought of present application. Meanwhile, for those ordinary skilled in the art, embodiments and the application scope may be changed in accordance with the thought of the present application. In conclusion, the contents of the description shall not be interpreted as a limitation to the present application.

1. A direct memory access controller, comprising a plurality of read descriptor management modules, a plurality of write descriptor management modules, a read data mover and a write data mover, wherein one read descriptor management module corresponds to one physical function management channel or one virtual function management channel, and one write descriptor management module corresponds to one physical function management channel or one virtual function management channel;
the read descriptor management modules are configured for converting contents in an obtained descriptor register into read descriptors and converting read descriptor data into read descriptors;
the write descriptor management modules are configured for converting write descriptor data into write descriptors;
the read data mover is configured for sending a read request to a host computer according to the read descriptors, receiving first data corresponding to the read request and processing the data;
wherein the write data mover is configured for reading corresponding second data according to the write descriptors and generating a write request based on the second data to send the write request to the host computer.

2. The direct memory access controller according to claim 1, wherein the read descriptor management modules comprise a register-to-descriptor unit and a first data-to-descriptor unit;
the register-to-descriptor unit is configured for obtaining a read descriptor register and a write descriptor register and converting contents in the registers into read descriptors that conform to a handshake protocol;
the first data-to-descriptor unit is configured for obtaining read descriptor data and converting the read descriptor data into read descriptors that conform to the handshake protocol.

3. The direct memory access controller according to claim 2, wherein the write descriptor management modules further comprise a first merging unit and a first first-in first-out memory;
the first merging unit is configured for polling and merging the read descriptors outputted by the register-to-descriptor unit and the read descriptors outputted by the data-to-descriptor unit by packets;
the first first-in first-out memory is configured for caching the read descriptors outputted by the first merging unit and sending the read descriptors to the read data mover.

4. The direct memory access controller according to claim 2, wherein the write descriptor management modules further comprise a determining unit;
the determining unit is configured for obtaining a write completion information group sent by the write data mover, a read completion information group sent by the read data mover, a read descriptor register and a write descriptor register, generating an interrupt for a relevant physical function/virtual function according to the write completion information group/read completion information group, and generating completion status information for the relevant descriptors.

5. The direct memory access controller according to claim 1, further comprising:
a second merging unit connected with the read descriptor management module and the read data mover for polling and merging the read descriptors outputted by each read descriptor management module by packets and forwarding the read descriptors to the read data mover.

6. The direct memory access controller according to claim 1, further comprising a first protocol conversion module connected with the host computer and the write descriptor management modules; wherein,
the first protocol conversion module is configured for converting received transaction layer data packets of a high-performance expansion bus protocol into transaction layer data packets of a peripheral bus protocol;
the first protocol conversion module comprises a completer request interface and a completer completion interface; the completer request interface is configured for receiving a request packet sent by the host computer; and the completer completion interface is configured for returning a completion packet to the host computer.

7. The direct memory access controller according to claim 6, wherein the first protocol conversion module comprises a request receiving unit, a protocol conversion unit and a sending unit of completion packets with data;
the request receiving unit is configured for receiving and parsing the request packet through the completer request interface, and converting parsed request data into request data of the handshake protocol;
the protocol conversion unit is configured for converting the request data of the handshake protocol into request data of the peripheral bus protocol and sending the request data to a corresponding read descriptor management module through a peripheral bus;
the sending unit of completion packets with data is configured for assembling completion packets with data and sending the packets to the host computer.

8. The direct memory access controller according to claim 6, further comprising a second protocol conversion module connected with the first protocol conversion module; wherein
the second protocol conversion module is configured for converting data packets of the peripheral bus protocol into data packets of the high-performance expansion bus protocol, so that business module buses are interconnected.

9. The direct memory access controller according to claim 1, wherein the write descriptor management modules comprise a second data-to-descriptor unit and a second first-in first-out memory;
the second data-to-descriptor unit is configured for obtaining the write descriptor data and converting the write descriptor data into write descriptors that conform to the handshake protocol;
the second first-in first-out memory is configured for caching the write descriptors outputted by the second data-to-descriptor unit and sending the write descriptors to the write data mover.

10. The direct memory access controller according to claim 1, further comprising:
a third merging unit connected with the write descriptor management modules and the write data mover for polling and merging the write descriptor outputted by each write descriptor management module by packets and forwarding the write descriptors to the write data mover.

11. The direct memory access controller according to claim 1, further comprising:
a descriptor status upload module for converting status information after the completion of the read descriptors and the write descriptors into transaction layer data packets of a write request type and sending the data packets to the host computer.

12. The direct memory access controller according to claim 1, further comprising:
a third protocol conversion module connected with the read data mover, the write data mover and an external memory for converting the data transmitted by the read data mover and the write data mover respectively to the external memory into the high-performance expansion bus protocol.

13. The direct memory access controller according to claim 1, wherein the write data mover comprises a write calculation control unit, a third first-in first-out memory, a write request sending unit, a sending control unit and a read control unit;
the write calculation control unit is configured for receiving the write descriptor, splitting the write descriptor into a write destination address and a write data length, and sending the write descriptor to the read control unit;
the read control unit is configured for reading corresponding second data from an external memory according to the write descriptor and sending the second data to the write request sending unit;
the write request sending unit is configured for generating transaction layer data packets based on the second data sent by the read control unit and sending the transaction layer data packets to the sending control unit;
the sending control unit is configured for generating a write request and sending the write request to the host computer when the data volume of the received transaction layer data packets meets sending conditions of the bus protocol.

14. The direct memory access controller according to claim 13, wherein the write data mover further comprises a third first-in first-out memory connected with the read control unit, and a data cache unit connected with the third first-in first-out memory and the write request sending unit;
the third first-in first-out memory is configured for storing the second data sent by the read control unit and forwarding the second data to the data cache unit;
the data cache unit is configured for caching the second data sent by the third first-in first-out memory in two-word units, and sending the cached data to the write request sending unit when the volume of the cached data meets the sending conditions of the write request sending unit.

15. The direct memory access controller according to claim 1, wherein the read data mover comprises a read calculation control unit, a splitting unit, a read request sending unit, a storage unit of completion packets with data, a receiving unit of completion packets with data and a write control unit;
the read calculation control unit is configured for receiving the read descriptor and splitting the read descriptor into a read destination address and a read data length;
the splitting unit is configured for generating three pieces of read operation information, with each piece of read operation information comprising the read destination address and the read data length, sending one piece of read operation information to the read request sending unit, and sending two pieces of read operation information to the write control unit;
the read request sending unit is configured for packing the read destination address and the read data length to obtain a read request, and sending the read request to the host computer;
the receiving unit of completion packets with data is configured for receiving completion packets with data sent by the host computer through the requester completion interface, preprocessing data for the completion packets with data, and then forwarding the preprocessed completion packets with data to the receiving unit of completion packets with data;
the storage unit of completion packets with data is configured for storing the preprocessed completion packets with data and forwarding the preprocessed completion packets with data to the write control unit;
the write control unit is configured for controlling a write address and a write length of the external memory according to the read operation information, generating corresponding read completion information or read descriptor data or write descriptor data according to the read operation information and the completion packets with data, sending the read completion information or the read descriptor data to the read descriptor management modules, and sending the write descriptor data to the write descriptor management modules.

16. (canceled)

17. (canceled)

18. A heterogeneous device, comprising the direct memory access controller according to claim 1.

19. A direct memory access system, comprising a host computer and the direct memory access controller according to claim 1, wherein the host computer is connected with the direct memory access controller through a high-speed serial computer expansion bus standard interface.

20. A server, connected with the direct memory access controller according to claim 1 and configured for data interaction with the direct memory access controller.

21. A direct memory access method, applied to the direct memory access controller according to claim 1, comprising:
converting, by the read descriptor management modules, contents in an obtained descriptor register into read descriptors, and converting read descriptor data into read descriptors;
converting write descriptor data into write descriptors by the write descriptor management modules;
sending, by the read data mover, a read request to the host computer according to the read descriptors, receiving first data corresponding to the read request and processing the data; and
reading, by the write data mover, corresponding second data according to the write descriptors, and generating a write request based on the second data to send the write request to the host computer.

22. A non-transitory computer readable storage medium, configured for storing computer programs, wherein the computer programs, when executed by a processor, implement the direct memory access method according to claim 21.
